(19) United States
(12) Patent Application Publication
(10) Pub. No.: US 2005/0243769 A1
(43) Pub. Date: Nov. 3, 2005

(54) Apparatus and method capable of pre-keying associations in a wireless local area network

(76) Inventors: Jesse R. Walker, Portland, OR (US); Emily H. Oi, Portland, OR (US)

Correspondence Address: INTEL CORPORATION, P.O. BOX 5326, SANTA CLARA, CA, 95056-5326, US

(21) Appl. No.: 10/833,463

(22) Filed: Apr. 28, 2004

(51) Int. Cl. H04Q 7/00; H04Q 7/24; H04L 12/28; H04L 12/56

(52) U.S. Cl. 370/331; 370/338

(57) ABSTRACT

Briefly, in accordance with one embodiment of the invention, is an apparatus 115, comprising: a first Access Point (AP) 120 capable of wireless communication with said apparatus 115; a second Access Point (AP) 105 in communication with said first Access Point (AP) 120; and a pre-authentication channel 125 between said apparatus 115 and said second Access Point 105 via said first Access Point (AP) 120, said pre-authentication channel 125 enabling pre-keying associations between said apparatus and said second Access Point (AP) 105.

### BACKGROUND

Wireless networking hardware requires the use of underlying technology that deals with radio frequencies as well as data transmission. The most widely used standard is 802.11 produced by the Institute of Electrical and Electronic Engineers (IEEE). This is a standard defining all aspects of Radio Frequency Wireless networking. IEEE 802.11i defines a security architecture for IEEE 802.11 Wireless Local Area Networks (WLANs). One important component of this new architecture is its key management protocol, which is called the 4-Way Handshake. IEEE 802.11i may use a 4-Way Handshake to establish cryptographic session keys that may be used to protect subsequent data packets. Although they 4-Way Handshake is an IEEE 802.11i exchange, the protocol may be implemented using IEEE 802.1X messages.

A limitation of IEEE 802.11i architecture is it may only be used after a mobile Wireless Local Area Network Station (STA) associates with an AP. This is because IEEE 802.11i defines a fixed sequence of steps: discovery, associate, authenticate, establish keys, and transfer data. This means that under the architecture it may not be feasible to protect any exchanged packets prior to the completion of the 4-Way Handshake. In particular, this may leave the 802.11 management frames subject to direct attack. This may include the traditional management frames such as Associate, Disassociate, and Deauthenticate, but may also include newer mechanisms, such as the IEEE 802.11k radio measurement frames. Attacks against Associate, Disassociate, and Deauthenticate frames may permit an adversary to inflict new denial-of-service attacks and to hijack legitimate sessions. Attacks against radio measurement frames can undermine the ability to improve the user experience by optimizing the connection. Thus, there is a continuing need for better ways provide a security architecture for IEEE 802.11 wireless communications including Wireless Local Area Networks (WLANs), and thus enable more secure, efficient and reliable wireless communications and networking.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a message flow path used by a pre-authentication channel;

FIG. 2 illustrates a message flow over a pre-authentication channel in the normal case; and

FIG. 3 depicts a message flow over a pre-authentication channel in the error case.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

Currently, wireless cryptographic techniques may only be available after an 802.11 association. This makes it difficult to protect any IEEE 802.11 management message prior to the completion of the 4-Way Handshake, which occurs only after association. This means that the Associate message cannot be protected, and as a consequence it makes no sense to protect the Disassociate and Deauthenticate messages, either. An embodiment of the present invention may put cryptographic session keys in place prior to association, so these keys could in principle be used to protect management frames as well as data frames, including Associate messages.

An embodiment of the present invention may also provide the reordering of the session establishment sequence, so that the only transition delay encountered moving from one AP to a second is the association delay. Empirical measurements show that the 4-Way Handshake may require about 40 milliseconds, and an embodiment of the present invention may allow inter-AP transition times on the order of 10 milliseconds, which may be fast enough for VoIP.

Because authentication is a time-consuming process, IEEE 802.11i in addition to the functionality listed above, also defines an optional mechanism called pre-authentication, to permit a mobile WLAN Station (STA) to authenticate using IEEE 802.1X prior to transitioning from one Access Point (AP) to another. Pre-authentication works by having the mobile STA communicate with a new AP via the AP with which it is already associated. That is, the STA sends the old AP an IEEE 802.1X authentication message for the new AP, and the old AP forwards this message to the new AP. The old AP thus serves as a proxy between the STA and the new AP, forwarding all of the IEEE 802.1X authentication messages forming this conversation.

Typically, although the present invention is not limited in this respect, the old AP and new AP may communicate via a Distribution System (DS). This may be an Ethernet, to which the APs are connected. The DS may provide a means for the first and second AP to communicate without resorting to radios.

The STA may communicate with the first AP via its association. The first AP may communicate with the second AP via the DS. The pre-authentication channel therefore may be comprised of the STA-first AP association and the first AP-second AP channel over the DS. Pre-authentication Ethertype packets may form a tunnel from the STA and the second AP over this channel.

Pre-authentication can significantly shorten the service interruption during the transition from one AP to another, typically from a couple of seconds to something on the order of 50 milliseconds. Although these times are merely illustrative of the performance capabilities and not meant to limit the present invention to give interrupt times as it is anticipated that a vast array of interrupt time are within the scope of the present invention. This may be almost, but not quite, good enough to support Voice over IP (VoIP) and similar real-time applications.

The present invention may provide IEEE 802.11i key caching of Pairwise Master Keys (PMKs), a new 4-Way Handshake Request message, a new Reject message, 4-Way handshake messages and the IEEE 802.11i pre-authentication framework. The present invention may reuse cached PMKs in a way already intended by the IEEE 802.11i specification: a means to optimize away unneeded authentications on subsequent visits to an AP.

The present invention may use a new 4-Way Handshake Request message to trigger the 4-Way Handshake. Further, the Request message may take two parameters, the MAC address of the requesting STA and the IEEE 802.11i key identifier of the cached PMK that will be used.

The Reject message may indicate the Request cannot be fulfilled, because the appropriate PMK is not cached, and conveys the same parameters as the Request.

One embodiment of the present invention may reuse the IEEE 802.11i pre-authentication framework to execute the 4-Way Handshake prior to association. This is feasible, because IEEE 802.11i may express a 4-Way Handshake message as IEEE 802.1X messages, and the pre-authentication mechanism can forward IEEE 802.1X messages. The pre-authentication framework may create what is termed herein a pre-authentication channel between the STA and the targeted AP via the currently associated AP. The pre-authentication framework may be created by wrapping IEEE 802.1X message payloads in an 802 frame with the pre-authentication Ethertype (88-C7). The Ethertype may inform the currently associated AP to forward the frames instead of process them itself. The pre-authentication frames may be addressed with one of the STA's or targeted AP's as the ultimate frame sender and the other as ultimate receiver.

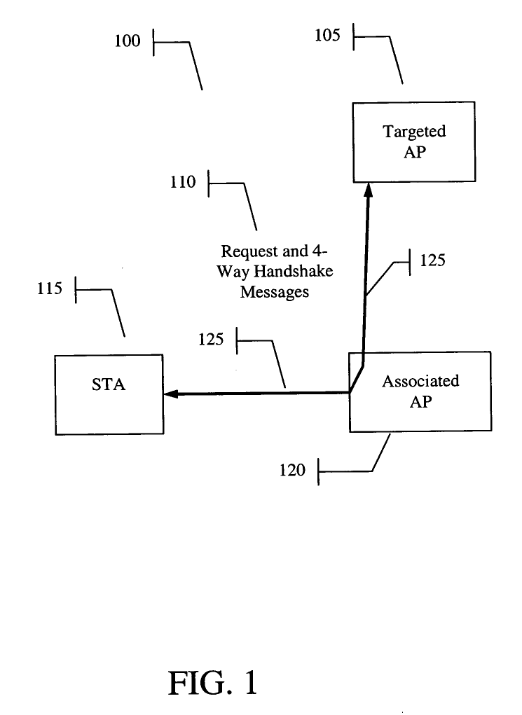

Turning now to the Figures, FIG. 1, shown generally as 100, illustrates a message flow path used by a pre-authentication channel. Depicted in FIG. 1 is an apparatus 115, comprising: a first Access Point (AP) 120 capable of wireless communication with said apparatus 115; a second Access Point (AP) 105 in communication with said first Access Point (AP) 120; and a pre-authentication channel 125 between said apparatus 115 and said second Access Point 105 via said first Access Point (AP) 120, said pre-authentication channel 125 enabling pre-keying associations between said apparatus and said second Access Point (AP) 105.

Although the present invention is not limited in this respect, the apparatus 115 may be a mobile Wireless Local Area Network Station (STA). Further, the first AP 120 may communicate with said second AP 105 via a wireless LAN Distributed System.

The pre-authentication channel between said apparatus 115 and said second Access Point 105 via said first Access Point (AP) 120 may be created from an IEEE 802.11i pre-authentication framework by wrapping IEEE 802.1X message payloads in an 802 frame with the pre-authentication Ethertype. Although the present invention is not limited in this respect as other pre-authorization frameworks are anticipated to be within the scope of the present invention and the aforementioned is but one illustrative example of pre-authentication methodologies.

An embodiment of the present invention may provide that the IEEE 802.11i pre-authentication framework may be used to execute an IEEE 802.11i 4-Way Handshake prior to association. The 4-Way Handshake Request message 110 may be used to trigger the 4-Way handshake. Although, it is anticipated that other methods are possible to initiate a handshake request and indeed other handshake methods in addition to the 4-way handshake are intended to be within the scope of the present invention and the 4-way handshake is but one illustrative example for an embodiment of the present invention.

Although the present invention is not limited in this respect, the Ethertype may tell the currently associated first AP 120 to forward frames across the DS to the second AP 105 instead of processing them itself and the pre-authentication frames may be addressed with the STA 115 or the second AP 105 as the ultimate frame sender and the other as ultimate receiver

The 4-Way Handshake Request message 110 may take two parameters: the MAC address of the requesting STA 115 and the IEEE 802.11i key identifier of a cached IEEE 802.11i Pairwise Master Key (PMK) that will be used in the 4-Way Handshake. However, the present invention is not limited in this respect as other parameters are possible to form a 4-Way Handshake message and are intended to be within the scope of the present invention.

Although the present invention is not limited in this respect, the Transmit Address of the Request message 110 may be the MAC address of said STA 115 and the Destination Address of said Request 115 may be the BSSID of the second AP 105, and the Receive Address of the Request 115 may be the first AP 120.

Although the present invention is not limited in this respect, the apparatus 115 may utilize IEEE 802.11i key caching of Pairwise Master Keys (PMKs), a 4-Way Handshake Request message, a Reject message, 4-Way Handshake messages and an IEEE 802.11i pre-authentication framework to enable the pre-keying associations between said apparatus 115 and the second Access Point (AP) 120.

A Reject message may indicate a Request 115 cannot be fulfilled because an appropriate PMK is not cached, and the Reject message may convey the same parameters as said Request. 115.

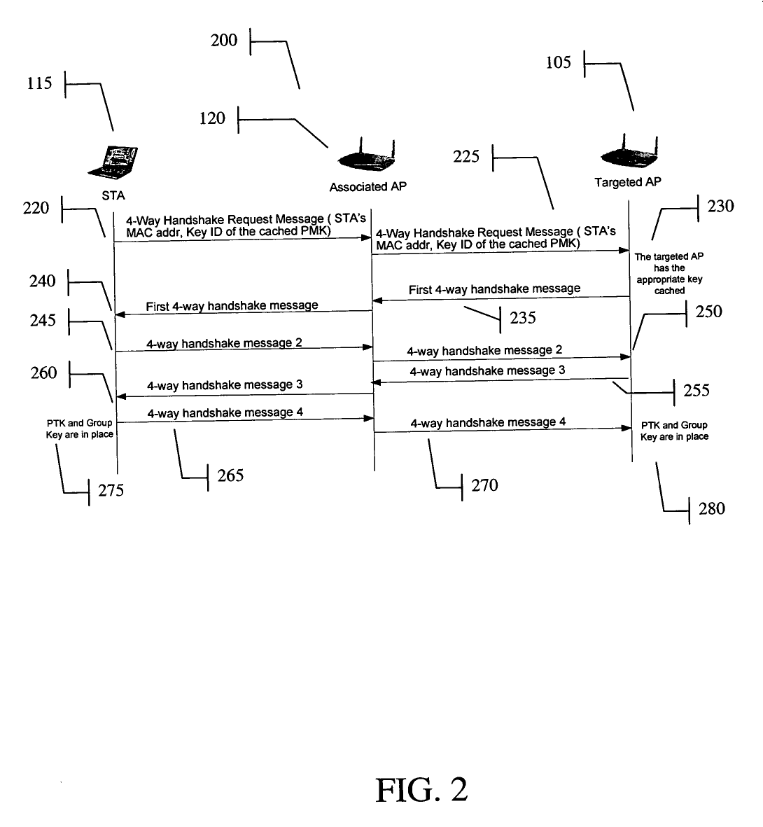

Turning now to FIG.2, illustrated generally at 200, is a message flow over a pre-authentication channel 125 in the normal case. After establishing a secure channel with an AP 120, the STA 115 watches for another AP 105 with which it might later associate. Although one AP is used in one embodiment of the present invention, the STA 115 may search any number of potential APs and also may select any number of APs for possible pre-authentication with STA 115. Also, although one STA 115 is illustrated in one embodiment of the present invention, any number of STAs can search for and being pre-authenticated with any number of future APs. Further, although one STA is illustrated in one embodiment of the present invention, it is anticipated that any number and types of apparatus that are capable of wireless communication are intended to be within the scope of the present invention.

When a STA 115 identifies a potential AP 105, the STA 115 checks its IEEE 802.11i key cache for an entry for that AP 105. If the STA 115 does not have an IEEE 802.11i Pairwise Master Key (PMK) cached for that AP 105, it initiates a process to insert such a PMK into its cache, for instance, by executing IEEE 802.11i pre-authentication. Although executing IEEE 802.11i pre-authentication is illustrated in one embodiment of the present invention, it is anticipated to be within the scope of the present invention to utilize any pre-authentication techniques now known or later developed.

If the STA 115 detects it has a PMK cached for the targeted AP 105 (shown at 230), at 220 it sends a 4-Way Handshake Request 110 message to the targeted AP 105 via the AP 120 with which it is currently associated and the pre-authentication channel 125. The transmission from AP 105 to AP 120 is shown at 225. Instead of the normal IEEE 802.1X Ethertype, the STA 115 may use the IEEE 802.11i pre-authentication Ethertype (88-C7) to indicate this message will be sent via the pre-authentication framework. Although, the present invention is not limited in this respect. The contents of the Request message 110 may include the MAC address of the requesting STA 115 and the key identifier of the cached PMK, although the present invention is not limited in this respect. The Transmit Address of this message may be the MAC address of the STA 115; the Destination Address of the Request 110 may be the BSSID of the targeted AP 105, and the Receive Address of the Request 110 may be the currently associated AP 120, although the present invention is not limited to this address methodology.

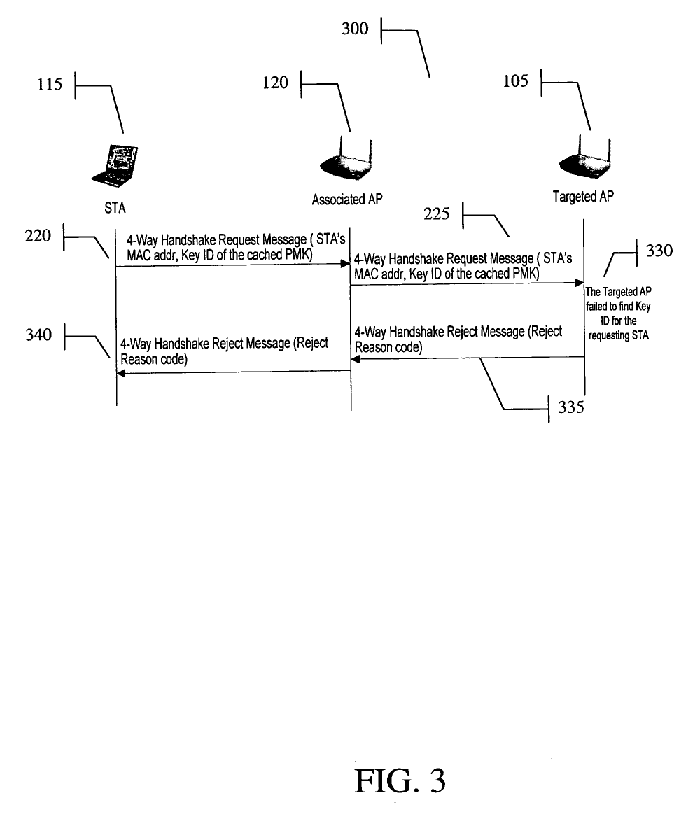

When it receives the message, the currently associated AP 120 may forward it to the targeted AP 105 (shown at 225), since this may be an IEEE 802.1X message of Ethertype pre-authentication and addressed to the targeted AP. When it receives the forwarded message from the associated AP 120, the targeted AP 105 may check its IEEE 802.11i PMK cache. If this fails to contain a key indexed by the Requesting STA's 115 MAC address or the requested key identifier (shown in FIG. 3 at 330), the targeted AP 105 may return a Reject message (shown in FIG. 3 at 335 from targeted AP to associated AP 120; and in FIG. 3 at 340 from associated AP 120 to STA 115) to the STA 115 via the associated AP 120; although the present invention is not limited to this technique of forwarding and returning a key indexed by the Requesting STA 115. The AP 120 may send the Reject using the pre-authentication Ethertype. Although, the present invention is not limited to using the pre-Ethertype for rejection sending.

If the targeted AP 120 has the appropriate key cached, it responds by initiating the IEEE 802.11i 4-Way Handshake using the selected PMK and STA 115 MAC address. However, since the Request came via the pre-authentication channel, the AP 120 may send the first 4-Way Handshake message to the STA 115 via the associated AP 120, using the pre-authentication channel 125 (shown at 235 and 240).

If it receives a Reject message from the targeted AP 120 via the pre-authentication channel 125, the STA 115 may establish a new PMK for that AP 120. If instead the STA 115 receives the first 4-Way Handshake message on the pre-authentication channel 125, the STA 115 responds with the second 4-Way Handshake message on the pre-authentication channel 125 (shown at 245 and 250).

If the targeted AP 120 receives a valid second 4-Way Handshake message from the STA 115 over the pre-authentication channel 125, it responds by sending the third 4-Way Handshake message back to the STA 115 over the pre-authentication channel 125 (shown at 255 and 260). If the STA 115 receives a valid third 4-Way Handshake message from the targeted AP 120 over the pre-authentication channel 125, then it has successfully established a secure session with that AP 120. The STA 115 may respond by sending the last 4-Way Handshake message to the targeted AP 120 over the pre-authentication channel 125 (shown at 265 and 270) and configuring the session keys; the STA 115 may exchange secured messages to the targeted AP 120 at this point.

If the target AP 120 receives a valid fourth 4-Way Handshake message from the STA 115 over the pre-authentication channel 125, then it has successfully established as secure session with the STA 115. The targeted AP 120 may respond by configuring the session keys; the AP 120 may exchange secured messages to the STA 115 at this point as the PTK and group keys are in place as shown at 275 for STA 115 and 280 for targeted AP 105,

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a first Access Point (AP) capable of wireless communication with said apparatus;
a second Access Point (AP) in communication with said first Access Point (AP); and
a pre-authentication channel between said apparatus and said second Access Point via said first Access Point (AP), said pre-authentication channel enabling pre-keying associations between said apparatus and said second Access Point (AP).

2. The apparatus of claim 1, wherein said apparatus is a mobile Wireless Local Area Network Station (STA).

3. The apparatus of claim 1, wherein said first AP communicates with said second AP via a wireless LAN Distributed System.

4. The apparatus of claim 4, wherein said pre-authentication channel between said apparatus and said second Access Point via said first Access Point (AP) is created from an IEEE 802.11i pre-authentication framework by wrapping IEEE 802.1X message payloads in an 802 frame with a pre-authentication Ethertype.

5. The apparatus of claim 4, wherein said IEEE 802.11i pre-authentication framework is used to execute an IEEE 802.11i 4-Way Handshake prior to association.

6. The apparatus of claim 4 wherein said Ethertype tells the currently associated first AP to forward frames across said DS to said second AP instead of processing them itself and wherein said pre-authentication frames are addressed with said STA or said second AP as the ultimate frame sender and the other as ultimate receiver.

7. The apparatus of claim 5, wherein a 4-Way Handshake Request message is used to trigger said 4-Way Handshake.

8. The apparatus of claim 7, wherein said 4-Way Handshake Request message takes two parameters: the MAC address of said requesting STA and the IEEE 802.11i key identifier of a cached IEEE 802.11i Pairwise Master Key (PMK) that will be used in said 4-Way Handshake.

9. The apparatus of claim 8, wherein a Transmit Address of said Request message is a MAC address of said STA and the Destination Address of said Request is a BSSID of said second AP, and the Receive Address of said Request is said first AP.

10. The apparatus of claim 1, wherein said apparatus utilizes IEEE 802.11i key caching of Pairwise Master Keys (PMKs), a 4-Way Handshake Request message, a Reject message, and an IEEE 802.11i pre-authentication framework to enable said pre-keying associations between said apparatus and said second Access Point (AP).

11. The apparatus of claim 10, wherein said Reject message indicates a Request cannot be fulfilled because an appropriate PMK is not cached, and said Reject message conveys the same parameters as said Request.

12. A method of pre-keying associations with an apparatus in a wireless local area network, comprising:
providing a first Access Point (AP) capable of wireless communication with said apparatus;
providing a second Access Point (AP) in communication with said first Access Point (AP); and
enabling pre-keying associations between said apparatus and said second Access Point (AP) by providing a pre-authentication channel between said apparatus and said second Access Point via said first Access Point (AP).

13. The method of claim 12, wherein said apparatus is a mobile Wireless Local Area Network Station (STA).

14. The apparatus of claim 12, wherein said first AP communicates with said second AP via a wireless LAN Distributed System.

15. The method of claim 13, wherein said pre-authentication channel between said apparatus and said second Access Point via said first Access Point (AP) is created from an IEEE 802.11i pre-authentication framework by wrapping IEEE 802.1X message payloads in an 802 frame with a pre-authentication Ethertype.

16. The method of claim 15, further comprising executing a 4-Way Handshake prior to association by using said IEEE 802.11i pre-authentication framework.

17. The method of claim 15 wherein said Ethertype tells the currently associated first AP to forward frames across said DS to said second AP instead of processing them itself and wherein said pre-authentication frames are addressed with said STA or said second AP as the ultimate frame sender and the other as ultimate receiver.

18. The method of claim 16, further comprising triggering said 4-way handshake with a 4-Way Handshake Request message.

19. The method of claim 18, wherein said 4-Way Handshake Request message takes two parameters: the MAC address of said requesting STA and the IEEE 802.11i key identifier of a cached IEEE 802.11i Pairwise Master Key (PMK) that will be used in the said 4-Way Handshake.

20. The method of claim 19, wherein the Transmit Address of said Request message is the MAC address of said STA and a Destination Address of said Request is a BSSID of said second AP, and the Receive Address of said Request is said first AP.

21. The method of claim 20, wherein said apparatus utilizes IEEE 802.11i key caching of Pairwise Master Keys (PMKs), a 4-Way Handshake Request message, a Reject message, and an IEEE 802.11i pre-authentication framework to enable said pre-keying associations between said apparatus and said second Access Point (AP).

22. The method of claim 21, wherein said Reject message indicates a Request cannot be fulfilled because an appropriate PMK is not cached, and said Reject message conveys the same parameters as said Request.

23. An article comprising a storage medium having stored thereon instructions, that, when executed by a computing platform, enables pre-keying associations between an apparatus in a wireless local area network and a second Access Point in said wireless local area network via a first Access Point in said wireless local area network that is in communication with said second Access Point (AP), by providing a pre-authentication channel between said apparatus and said second Access Point via said first Access Point (AP).

24. The article of claim 23, wherein said apparatus is a mobile Wireless Local Area Network Station (STA).

25. The article of claim 23, wherein said pre-authentication channel between said apparatus and said second Access Point via said first Access Point (AP) is created from an IEEE 802.11i pre-authentication framework by wrapping IEEE 802.1X message payloads in an 802 frame with the pre-authentication Ethertype.

26. The article of claim 25 wherein said Ethertype tells the currently associated first AP to forward frames instead of processing them itself and wherein said pre-authentication frames are addressed with said STA or said second AP as the ultimate frame sender and the other as ultimate receiver.
